(19) United States
(12) Patent Application Publication
(10) Pub. No.: US 2014/0308112 A1
(43) Pub. Date: Oct. 16, 2014

(54) SLIDE RING SEAL ARRANGEMENT WITH TESLA PUMP

(71) Applicant: EagleBurgmann Germany GmbH & Co. KG, Wolfratshausen (DE)

(72) Inventors: Stefan Ledig, Wolfratshausen (DE); Thomas Boehm, Zell (DE); Rudolf Kollinger, Konigsdorf (DE)

(73) Assignee: EAGLEBURGMANN GERMANY GMBH & CO. KG, Wolfratshausen (DE)

(21) Appl. No.: 14/357,355

(22) PCT Filed: Oct. 8, 2012
(86) PCT No.: PCT/EP2012/004207

§ 371 Date: May 9, 2014

(30) Foreign Application Priority Data
Nov. 10, 2011 (DE) 102011118294.6

(51) Int. Cl. F04D 5/00; F03B 5/00; F04D 17/16; F16J 15/34

(52) U.S. Cl. CPC F04D 5/001; F16J 15/34; F03B 5/00; F04D 17/161
USPC 415/90; 415/230

(57) ABSTRACT

The present invention refers to a mechanical seal assembly, comprising at least one mechanical seal (2) with a rotating seal ring (21) and a stationary seal ring (22), the rotating seal ring (21) and the stationary seal ring (22) defining a sealing gap (23) between them, and a Tesla pump (6) co-rotating with the rotating seal ring (21).

The present invention refers to a mechanical seal assembly, comprising at least one mechanical seal and a Tesla pump.

Mechanical seal assemblies are known from the prior art in different configurations. During operation, relatively high temperatures may occur on the mechanical seal; on the one hand, these may be due to a high temperature of a medium to be sealed or due to the friction and swirl powers created during normal operation on the mechanical seal. To prevent damage to the mechanical seal, heat must therefore be discharged. To this end the medium to be sealed can be used on condition that it does not have excessively high temperatures, or alternatively a barrier medium. For circulating the medium used for heat discharge, external pumps are normally used. Furthermore, it is known to provide so-called pump rings for medium circulation, but their delivery rate is normally very limited.

It is therefore the object of the present invention to provide a mechanical seal assembly which while having a simple and inexpensive structure allows improved circulation of a medium in the area of the seal rings and is nevertheless of a very compact structure.

This object is achieved by a mechanical seal assembly comprising the features of claim 1. The sub-claims refer to preferred embodiments of the invention.

The mechanical seal assembly according to the invention with the features of claim 1 has the advantage that an enhanced delivery rate of a barrier and/or cooling medium is possible without the need for significantly increasing the constructional space. This is achieved according to the invention in that the mechanical seal assembly comprises a Tesla pump. The Tesla pump comprises a plurality of radially outwardly extending discs which are arranged on a cylindrical base portion. The discs are spaced apart from each other at a defined distance, so that the medium, which penetrates between the discs, is transported by rotation of the discs to the outer circumference of the discs and exits there out of the Tesla pump. The Tesla pump has a simple and robust structure and enables a high delivery rate together with a long service life. The Tesla pump has a stable characteristic and only poses a very small risk of cavitation.

Preferably, the mechanical seal assembly further comprises an additional delivery device which is arranged upstream of the Tesla pump. The additional delivery device preferably comprises a delivery thread which is co-rotating with the Tesla pump. This particularly improves an inflow of the medium to the Tesla pump, so that the pumping capacity of the Tesla pump is increased. Particularly preferably, the delivery thread comprises oblique delivery grooves which are inclined relative to an axial direction of the mechanical seal assembly. The oblique delivery grooves have in particular the advantage that the medium to be delivered is subjected to a flow component in circumferential direction, so that the medium is introduced in a rather flow-promoting manner between the discs of the Tesla pump. This can particularly improve the efficiency of the Tesla pump.

The Tesla pump preferably comprises a plurality of discs and a cylindrical base portion, the discs extending from the cylindrical base portion radially to the outside. Preferably, at least one of the discs comprises at least one axial opening preferably positioned next to the base portion. Preferably, all discs, except for an end disc which is arranged on an axial end of the Tesla pump, comprise at least one axial opening. Particularly preferably, plural axial openings are provided in the discs and, further preferably, uniformly distributed along the circumference. The axial openings in the discs have the effect that the medium can flow near the cylindrical base portion of the Tesla pump into the region between the discs of the Tesla pump and can then be delivered through the Tesla pump spirally to the outside. The axial openings thereby further improve the efficiency of the pump. Particularly preferably, axial openings are arranged on adjacent discs of the Tesla pump at the same circumferential positions. It is thereby ensured that the medium is guided up to the end disc, which is without an axial opening. This can further improve the degree of efficiency.

According to an alternative configuration of the present invention all of the discs of the Tesla pump preferably comprise at least one axial opening. An axial opening is here provided in an end disc, which is arranged at an axial end of the Tesla pump, with a smaller passage cross-section than the other axial openings in the other discs. This permits a flow through all of the discs of the Tesla pump, whereby it is ensured that on the one hand the medium can be transported to all interspaces between the discs and further also that the medium can be transported into a region in flow direction behind the Tesla pump so as to permit a cooling of the components, especially of the seal rings, at that place.

The geometrical shape of the axial openings can be chosen at will, but it is preferably cylindrical or provided as an elongated hole, particularly an arched or straight elongated hole. Further preferably, the axial openings are provided at the bottom of the discs of the Tesla pump and further preferably are each arranged in a row one after the other to ensure a good flow therethrough at minimum losses, if possible. Preferably, several axial openings are evenly distributed along the circumference of the discs.

Further preferably, the discs of the Tesla pump have delivery structures on at least one flat side. The delivery structures may e.g. be elements which are arranged in the form of an arc and protrude from the flat side of the disc or may be protruding elements extending in a straight line radially. The delivery structures on the disc promote the transportation of the medium, a height of the delivery structures, starting from the flat side, being chosen such that the delivery performance of the Tesla pump is promoted in addition. As an alternative, delivery structures are provided on both flat sides of the discs, so that delivery structures protrude from both sides into the gap between the discs.

To achieve a situation where the medium to be conveyed can pass in an improved manner between the discs of the Tesla pump, an outer circumference of the Tesla pump expands continuously, especially conically. A Tesla pump with a substantially conical shell shape is formed, ensuring improved delivery. Particularly preferably, the discs are spirally arranged on the cylindrical base portion. Alternatively, the discs are arranged in parallel with each other and have different outer diameters. The outer diameters of the discs are increasing in axial direction. The sizes of the discs are here increasing preferably uniformly in axial direction, so that a conical outer shell is obtained on the Tesla pump.

Further preferably, the cylindrical base portion is configured as a hollow cylinder, and at least one passage opening that permits communication with a space inside the hollow cylinder is provided in the hollow cylindrical base portion. The space within the hollow cylinder is preferably led up to the seal rings, thereby enabling a flow of the medium through the passage opening up to the seal rings so as to improve cooling in the region of the seal rings. The passage opening is preferably provided as one or plural radial bores arranged along the circumference of the hollow cylinder.

For a particularly compact structure the delivery thread of the additional second delivery device is preferably arranged on an outside of a bushing. Further preferably, the bushing is arranged in the area of the delivery thread on a rotary sleeve, and the Tesla pump is arranged on a hollow shaft portion of the bushing next to a fastening region.

Further preferably, an outflow bore for the medium to be conveyed is arranged radially outside of the Tesla pump.

Further preferably, the mechanical seal assembly comprises a second mechanical seal, the Tesla pump being arranged in axial direction between a sealing gap of the first mechanical seal and a sealing gap of the second mechanical seal. This ensures a particularly compact structure of a double-acting mechanical seal assembly.

Preferably, the Tesla pump is part of a cooling device for cooling the seal rings and/or other components of the mechanical seal assembly.

Particularly when a very viscous cooling medium is used, e.g. for cooling mechanical seal assemblies subjected to high temperatures, the assembly of the invention with the Tesla pump can significantly improve the delivery efficiency as compared with the formerly used delivery devices.

Embodiments of the invention will now be described in detail with reference to the accompanying drawing, in which:

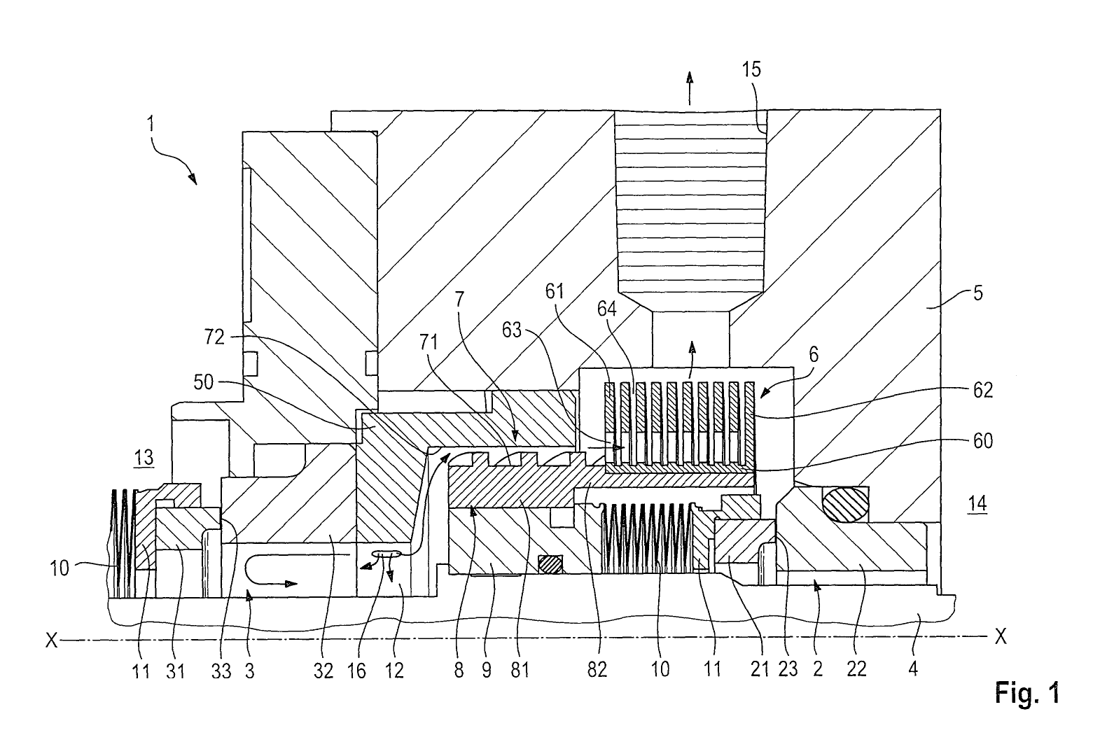

FIG. 1 is a schematic sectional view of a mechanical seal assembly according to a first embodiment of the invention;

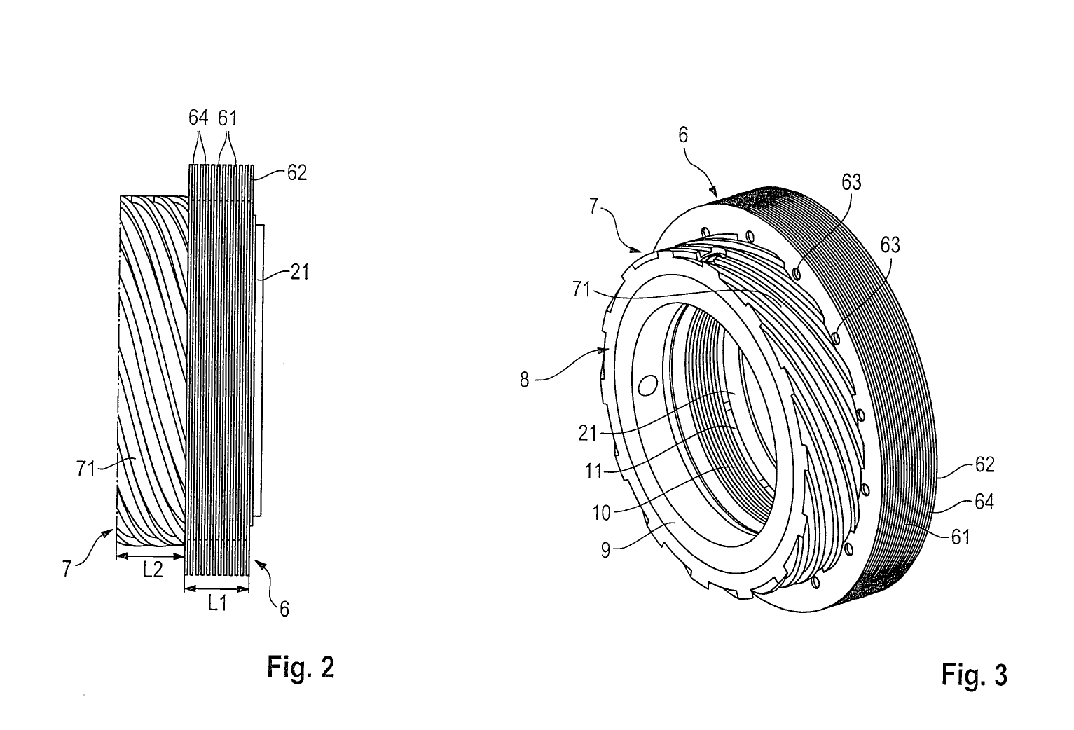

FIG. 2 is a schematic side view of a Tesla pump and a delivery thread of FIG. 1;

FIG. 3 is a schematic perspective view of FIG. 2;

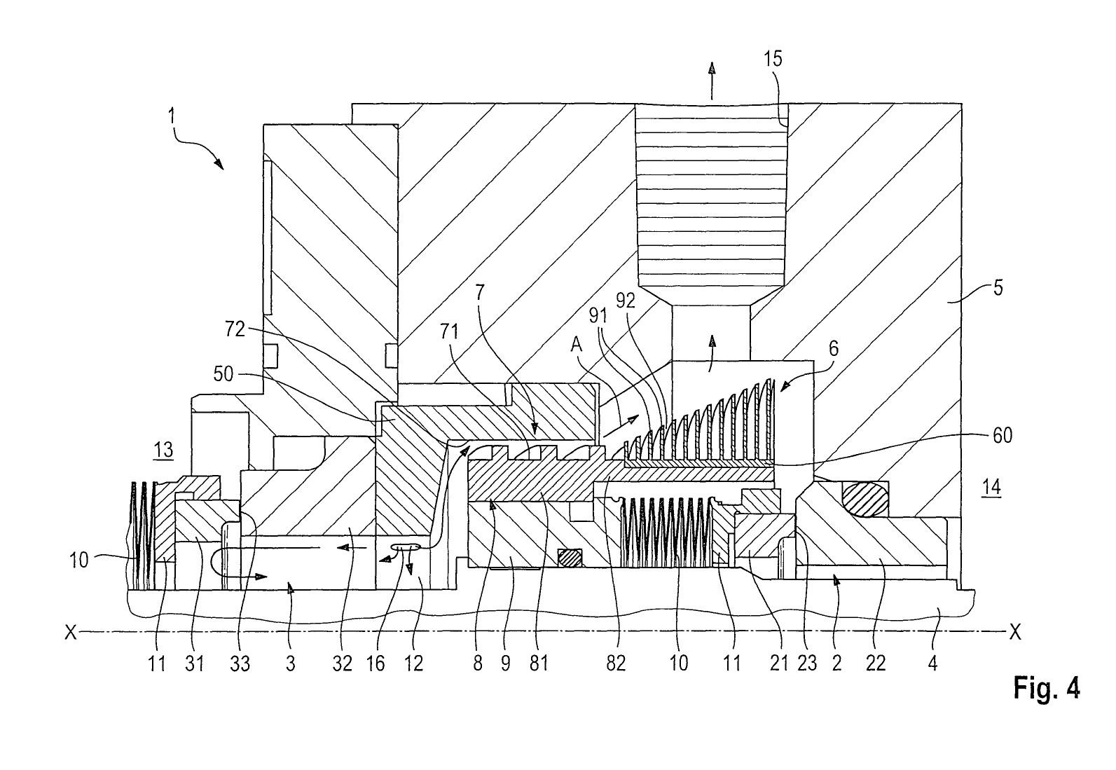

FIG. 4 is a schematic side view of a mechanical seal assembly according to a second embodiment of the invention;

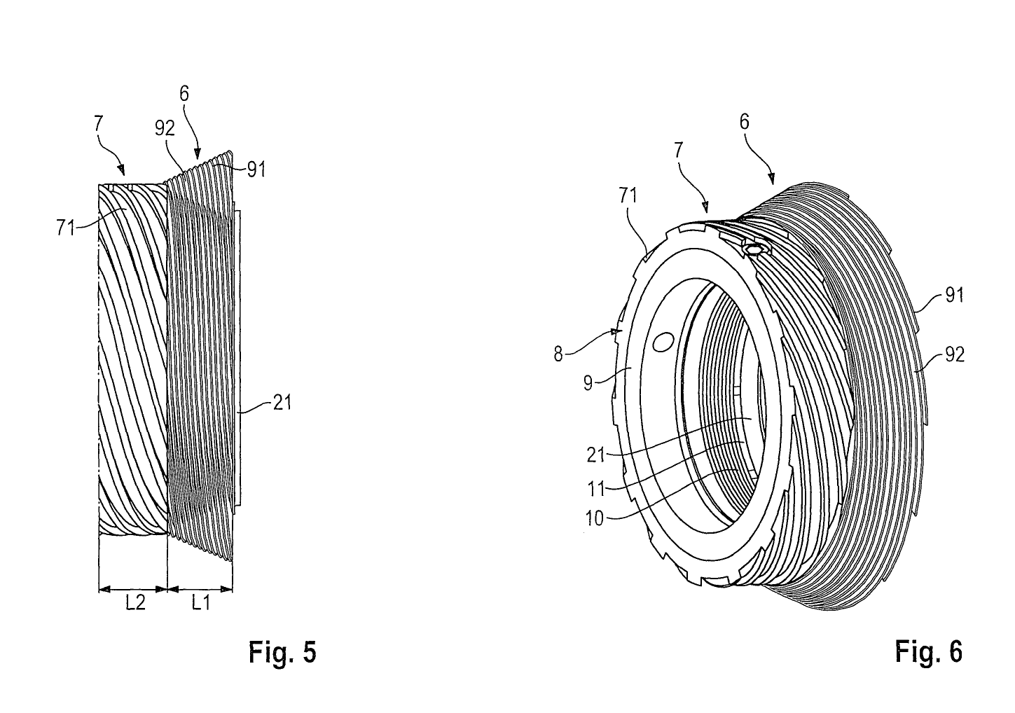

FIG. 5 is a schematic side view of a Tesla pump and a delivery thread of FIG. 4;

FIG. 6 is a schematic perspective view of FIG. 5; and

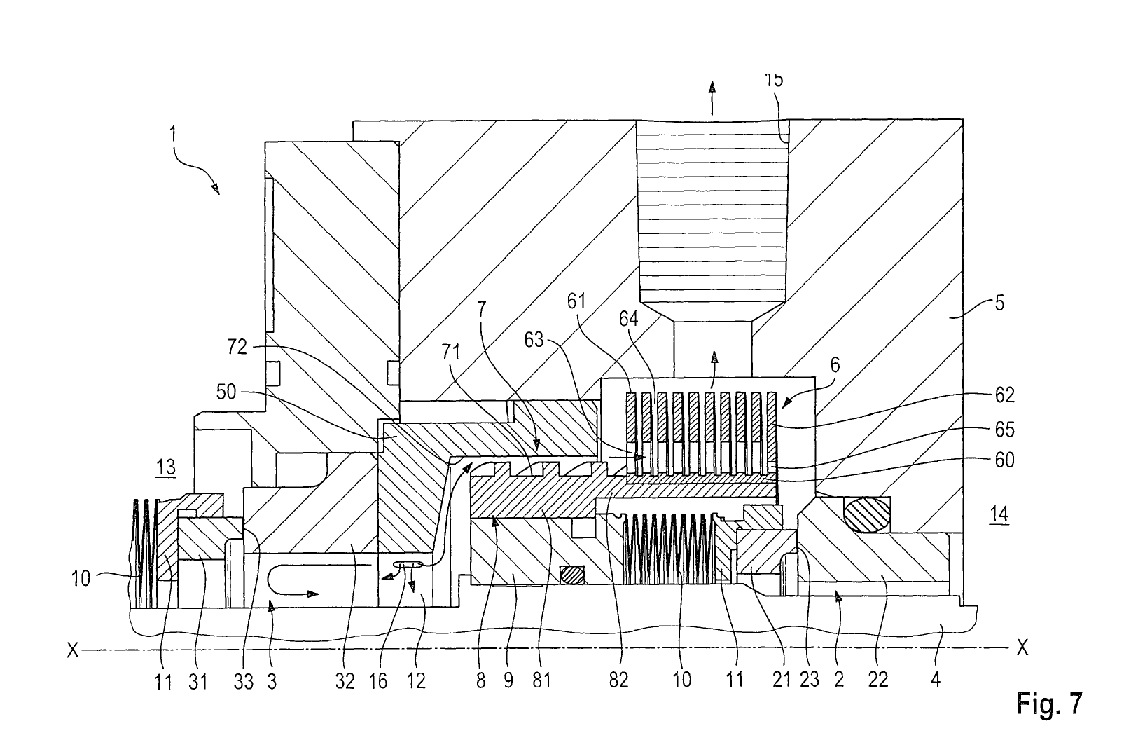

FIG. 7 is a schematic sectional view of a mechanical seal assembly according to a third embodiment of the invention;

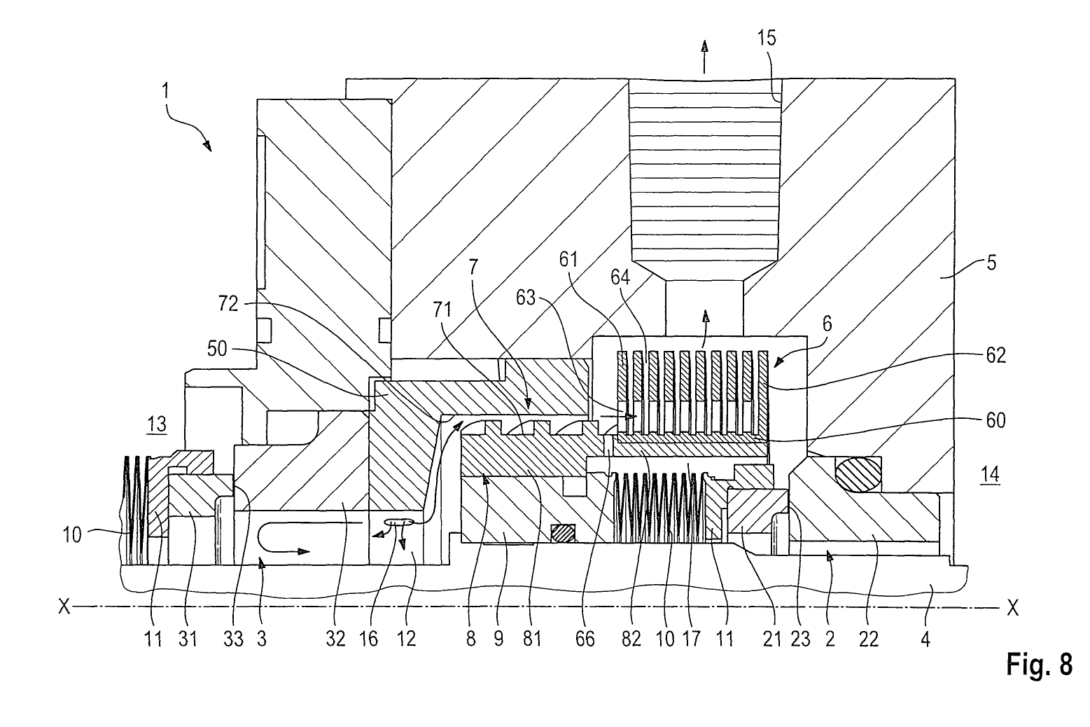

FIG. 8 is a schematic sectional view of a mechanical seal assembly according to a fourth embodiment of the invention;

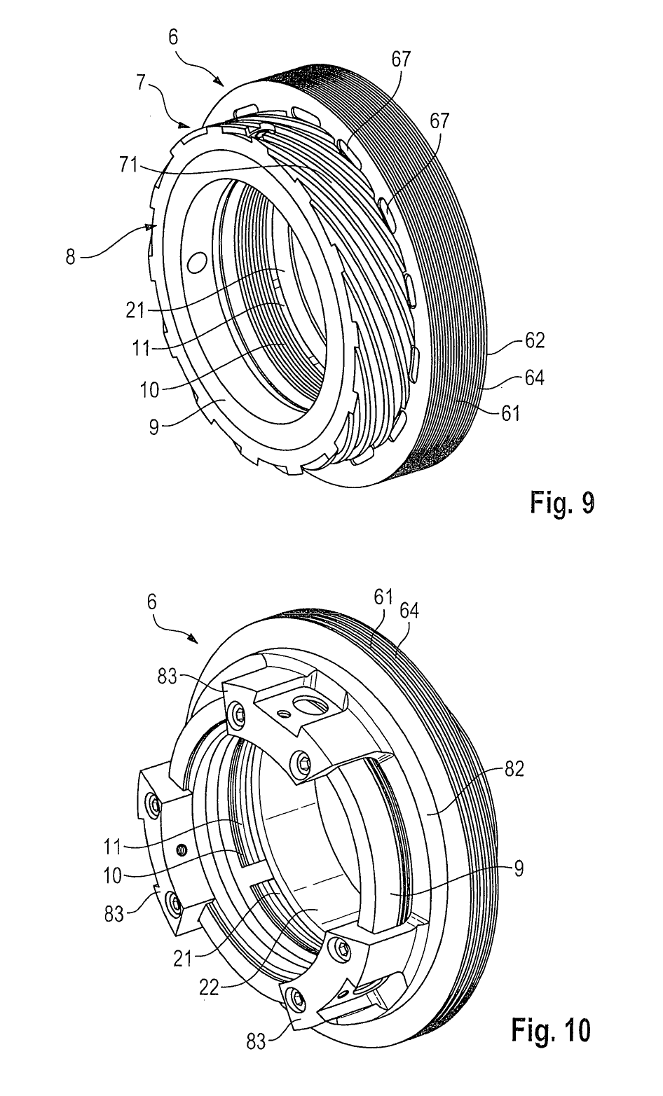

FIG. 9 is a schematic perspective view of a Tesla pump and of a delivery thread according to a fifth embodiment;

FIG. 10 is a schematic perspective view of a mechanical seal assembly according to a sixth embodiment of the invention; and

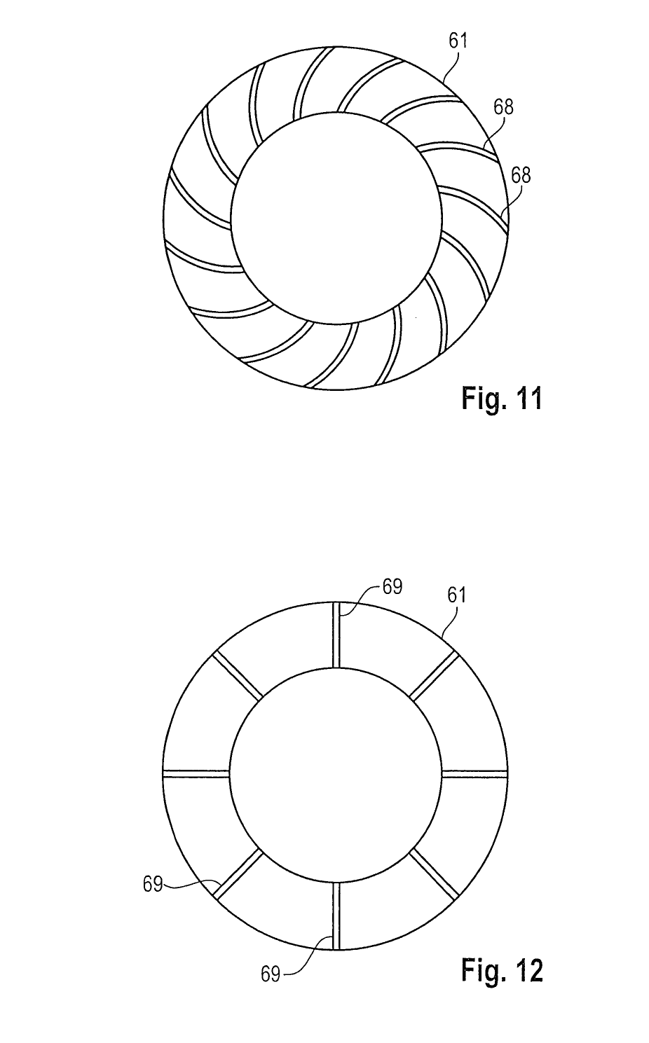

FIGS. 11 and 12 are views of discs of a Tesla pump with delivery structures.

A mechanical seal assembly 1 according to the first embodiment of the invention is shown in detail in FIGS. 1 to 3.

The mechanical seal assembly 1 comprises a first mechanical seal 2 and a second mechanical seal 3. The first mechanical seal 2 comprises a rotating seal ring 21 and a stationary seal ring 22, the two seal rings defining a sealing gap 23 between them. The second mechanical seal 3 comprises a rotating seal ring 31 and a stationary seal ring 32, the two seal rings also defining a sealing gap 33 between them. Hence, the mechanical seal assembly according to the first embodiment comprises a double-acting mechanical seal.

The rotating seal rings 21, 31 are each connected via a holding ring 11 to a rotating component 4, in this embodiment a rotating shaft. Furthermore, each of the two mechanical seals 2, 3 comprises a metal bellows 10 as a spring device. As can be seen from FIG. 1, the metal bellows 10 is fixed to a rotary sleeve 9 which is co-rotating with the rotating component 4. The stationary seal rings 22, 32 are directly or indirectly connected to a housing 5.

The mechanical seal assembly 1 of the invention seals a product side 13 against an atmosphere side 14.

Furthermore, the mechanical seal assembly 1 according to the invention comprises a Tesla pump 6 and a delivery thread 7 as a second delivery device. The delivery thread 7 and the Tesla pump are arranged on a bushing 8 which is fixed to the rotary sleeve 9. The Tesla pump 6 comprises a plurality of parallel discs 61, each having an axial opening 63. The axial openings 63 are here arranged cylindrically and evenly distributed along the circumference of the discs 61 (cf. FIG. 3) and are provided adjacent to a cylindrical base portion 60 of the Tesla pump. An end disc 62 which is arranged on an axial end of the Tesla pump 6 is here without an axial opening. The discs 61 and the end disc 62 are arranged such that constant interspaces 64 exist between the discs, a width of the discs 61 being equal to a width of the interspaces 64.

The delivery thread 7 comprises a plurality of grooves 71 which are obliquely arranged relative to an axial direction X-X of the mechanical seal assembly. A stationary part 72 of the delivery thread 7 is provided by way of a smooth outer surface of a stationary component 50. Hence, the illustrated delivery thread 7 is a rotating delivery thread. Alternatively, a stationary delivery thread may also be provided where the delivery grooves are provided in the stationary component and the smooth outer surface on the rotating component. Further alternatively, an opposing delivery thread may also be provided, wherein grooves are provided in the rotating component and also in the stationary component in opposing arrangement.

A cooling medium is fed via an inflow bore 16 into an interspace 12 between the rotating component 4 and the housing 5. As outlined by the arrows, the cooling medium is here delivered from the interspace 12 through the delivery thread 7 towards the Tesla pump 6. On the Tesla pump 6, the cooling medium flows into the axial openings 63 of the Tesla pump and is transported by the rotating discs spirally in radial direction to the outside and to an outflow bore 15. As can particularly be seen in FIG. 3, the cooling medium is acted upon by the grooves 71 of the delivery housing with a flow component in circumferential direction, so that the cooling medium enters into the axial openings 63 of the Tesla pump 6 in a flow-promoting manner with reduced flow resistance. Since the delivery thread 7 and the Tesla pump 6 are rotating on the same bushing 8 together with the rotating component 4, this allows an easy entry of the cooling medium into the Tesla pump. Since the interspaces 64 have a defined width between the discs 61, energy is transmitted by adhesion forces from the discs to the cooling medium and the cooling medium is conveyed spirally radially to the outside of the Tesla pump. Preferably, a cooling medium is here chosen such that it has a relatively high viscosity. The cooling medium is e.g. oil. The high viscosity of the cooling medium particularly improves the efficiency of the Tesla pump 6.

Hence, in the first embodiment the delivery thread 7 is arranged in flow direction upstream of the Tesla pump 6 and assumes a guiding function for the cooling medium, in addition to the delivery performance of the delivery thread 7, so that said medium can flow more easily into the interspaces 64 of the Tesla pump without the developing boundary layers of the medium being too much interfered with. The Tesla pump 6 is arranged on a hollow shaft portion 82 of the bushing 8 so that the Tesla pump 6 has as little mass as possible. This has the further advantage that the cooling medium can also pass into the portion of the metal bellows 10 on the first mechanical seal 2. The delivery thread 7 is provided on a fastening portion 81 of the bushing 8 which is connected to the rotary sleeve 9.

Although the Tesla pump 6 has a certain dimension in radial direction, it is very compact as regards its dimension, so that it can be installed without any problems under very different installation situations of mechanical seal assemblies because a necessary installation space does normally exist in radial direction of the mechanical seal assemblies on account of the stationary component. An axial length L1 of the Tesla pump is here equal to an axial length L2 of the delivery thread 7 (cf. FIG. 2). Furthermore, the delivery thread 7 and the Tesla pump 6 are arranged in axial direction X-X between the two sealing gaps 23, 33 of the two mechanical seals 2, 3.

Hence, owing to the inventive idea of integrating a Tesla pump 6 in a mechanical seal assembly, an improved delivery of a medium used for cooling or blocking the mechanical seals and components adjacent thereto can be ensured without the need for a large constructional space. The Tesla pump is here very robust and can be produced at very low costs, especially since it does not require any expensive components, such as blades or the like. Owing to the integration of the Tesla pump 6 it is furthermore possible to dispense with an external delivery device, such as e.g. a rotary pump or the like, for delivering the cooling fluid flow.

A second embodiment of the invention shall now be described with reference to FIGS. 4 to 6, wherein identical or functionally identical parts are designated with the same reference numerals as in the first embodiment. The second embodiment has substantially the same structure; in contrast to the first embodiment the Tesla pump 6 has a different structure.

As can particularly be seen in FIGS. 4 and 5, the Tesla pump 6 again comprises a cylindrical base portion 60 and a plurality of discs 91 with defined interspaces 92 provided between the discs. However, the discs 91 of the Tesla pump 6 of the second embodiment are of such a structure that the discs extend in a spiral form. Hence, the discs 91 have a spiral structure so that a spiral interspace 92 is obtained between the discs. The diameter of the discs 91 is here increasing in flow direction A of the medium. This yields a conical envelope for the Tesla pump. Furthermore, a thickness of the discs 91 is dimensioned such that the thickness is smaller than an intermediate space 92 between two neighboring discs 91. The Tesla pump thereby works with increased friction, whereby a maximum surface is offered for the developing boundary layers of the cooling medium. Otherwise, this embodiment corresponds to the preceding embodiment, so that reference can be made to the description of that embodiment.

Each of FIGS. 7 and 8 shows a further embodiment of a mechanical seal assembly according to the invention. In the third embodiment shown in FIG. 7, the Tesla pump comprises a plurality of discs 61, each of the discs 61 and particularly also an end disc 62 comprising an axial opening on an axial end of the Tesla pump. An axial opening 65 of the end disc 62 is here smaller, i.e., a passage cross-section is smaller than a passage cross-section of the other axial openings 63 in the discs 61, which cross section is respectively of the same size. The fourth embodiment shown in FIG. 8 conforms substantially to the first embodiment, a radial passage opening 66 being formed in the hollow shaft portion 82. Preferably, plural passage openings are provided along the circumference of the hollow shaft portion 82. As can be seen in FIG. 8, the passage openings 66 are provided in axial direction between the Tesla pump 6 and the delivery thread 7. A communication is established via the passage opening 66 with a space 17 in the interior of the hollow shaft portion 82. As can be seen in FIG. 8, the space terminates near the sealing gap 23 of the two seal rings 21, 22. This yields a fluid flow for cooling the seal rings 21, 22, the flow branching off from a portion after the delivery thread 7 through the radial passage opening 66 and being guided via the space 17 to the seal rings.

FIG. 9 shows a further preferred alternative configuration in which elongated holes 67 are provided instead of the axial openings 63 in the form of cylindrical bores. It is thereby possible to enlarge a fluid flow through the discs of the Tesla pump 6. The elongated holes are here formed to be straight or also arched in conformity with the outer radius on the delivery thread 7.

FIG. 10 shows a Tesla pump 6 for a mechanical seal assembly according to a sixth embodiment of the invention, wherein no additional delivery device is provided. This means that in this embodiment the medium is conveyed exclusively by means of the Tesla pump 6. The Tesla pump 6 is fixed via a hollow shaft portion 82 and three broad webs 83 to the shaft (not shown). This embodiment can thus be produced at particularly low costs because a second delivery device can be omitted. Furthermore, due to the omission of a second delivery device an axially compact and short constructional shape is in particular possible. Furthermore, an improved medium supply to the Tesla pump 6 is achieved owing to the circumferentially relatively broad interspace between the webs 83.

FIGS. 11 and 12 show two further alternative embodiments of discs 61 of the Tesla pump 6, in a top view. Delivery structures are provided on the flat sides of the disc 61. Arched protruding delivery elements 68 are provided in the case of the disc 61 of FIG. 11, and radially extending protruding delivery elements 69 are provided in the embodiment shown in FIG. 12. The protruding delivery elements are each formed equally distributed on the flat sides of the disc 61. It should be noted that the delivery structures may be provided only on one side of the discs and alternatively also on both sides of the disc. The height of the protruding delivery structures is here chosen such that despite the protruding delivery structures a relatively small interspace 64 exists between neighboring discs 61 and the delivery structures enhance the delivery rate of the Tesla pump 6. The delivery structures shown in FIGS. 11 and 12 can here be used in all of the embodiments described. Furthermore, it should be noted that the delivery structures may also be formed by providing channels, or the like.

### LIST OF REFERENCE NUMERALS

1 Mechanical seal assembly
2 First mechanical seal
3 Second mechanical seal
4 Shaft
5 Housing
6 Tesla pump
7 Delivery thread
8 Bushing
9 Rotary sleeve
10 Bellows
11 Holding ring
12 Interspace
13 Product side
14 Atmosphere side
15 Outflow bore
16 Inflow bore
17 Space
21 Rotating seal ring
22 Stationary seal ring
23 Sealing gap
31 Rotating seal ring
32 Stationary seal ring
33 Sealing gap
50 Housing component
60 Cylindrical base portion
61 Disc
62 End disc
63 Axial opening
64 Interspace
65 Axial opening in end disc
66 Radial passage opening
67 Elongated hole
68, 69 Protruding delivery element
71 Grooves
72 Mating face of the delivery thread
81 Fastening portion
82 Hollow shaft portion
83 Webs
91 Spiral discs
92 Spiral interspace
A Flow direction
L1 Axial length of the Tesla pump
L2 Axial length of the delivery thread

1. A mechanical seal assembly, comprising:
at least one mechanical seal with a rotating seal ring and a stationary seal ring, the rotating seal ring and the stationary seal ring defining a sealing gap between them; and
a Tesla pump which is co-rotating with the rotating seal ring.

2. The assembly according to claim 1, further comprising an additional delivery device which is arranged upstream of the Tesla pump.

3. The assembly according to claim 2, wherein the additional delivery device comprises a delivery thread which is co-rotating with the Tesla pump.

4. The assembly according to claim 3, wherein the delivery thread comprises oblique delivery grooves which are inclined relative to an axial direction of the assembly.

5. The assembly according to claim 1, wherein the Tesla pump comprises a plurality of discs and a cylindrical base portion.

6. The assembly according to claim 5, wherein the discs extend from the cylindrical base portion radially to the outside, at least one of the discs comprising at least one axial opening.

7. The assembly according to claim 6, wherein:
all discs, except for an end disc arranged at an axial end of the Tesla pump, comprise at least one axial opening, or
that all discs of the Tesla pump comprise at least one axial opening, particularly an axial opening in the end disc having a smaller average cross-section than the axial opening of the other discs.

8. The assembly according to claim 6, wherein the axial openings are cylindrical and/or that the axial openings are formed as an elongated hole and/or that the axial openings are evenly distributed along the circumference of the discs.

9. The assembly according to claim 6, wherein the axial openings of adjacent discs of the Tesla pump are arranged at the same circumferential positions of the discs.

10. The assembly according to claim 5, wherein the discs of the Tesla pump comprise delivery structures on at least one flat side, particularly on both flat sides.

11. The assembly according to claim 5, wherein the discs are arranged such that an outer circumference of the Tesla pump expands, particularly expands conically.

12. The assembly according to claim 11, wherein the discs are spirally arranged on the cylindrical base portion.

13. The assembly according to claim 5, wherein the cylindrical base portion is configured as a hollow cylinder and at least one passage opening is provided particularly in the base portion.

14. The assembly according to claim 3, wherein the delivery thread is arranged on an outside of a bushing.

15. The assembly according to claim 14, wherein the bushing comprises a fastening portion and a hollow shaft portion, the delivery thread being arranged on the fastening portion and the Tesla pump being arranged on the hollow shaft portion.

16. The assembly according to claim 1, further comprising a second mechanical seal, the Tesla pump being arranged in axial direction (X-X) between the sealing gap of the first mechanical seal and a sealing gap of the second mechanical seal.
